(19) United States
(12) Patent Application Publication
(10) Pub. No.: US 2014/0114652 A1
(43) Pub. Date: Apr. 24, 2014

(54) AUDIO CODING DEVICE, AUDIO CODING METHOD, AND AUDIO CODING AND DECODING SYSTEM

(71) Applicant: FUJITSU LIMITED, Kawasaki-shi (JP)

(72) Inventors: Yohei KISHI, Kawasaki (JP); Akira KAMANO, Kawasaki (JP); Shunsuke TAKEUCHI, Kawasaki (JP); Miyuki SHIRAKAWA, Fukuoka (JP); Masanao SUZUKI, Yokohama (JP)

(73) Assignee: FUJITSU LIMITED, Kawasaki-shi (JP)

(21) Appl. No.: 14/046,404

(22) Filed: Oct. 4, 2013

(30) Foreign Application Priority Data
Oct. 24, 2012 (JP) 2012-234870

(51) Int. Cl. G10L 19/028

(52) U.S. Cl. CPC G10L 19/028
USPC 704/205

(57) ABSTRACT

An audio coding device includes a processor; and a memory which stores a plurality of instructions, which when executed by the processor, cause the processor to execute, calculating a frequency spectrum characteristic of an input signal; defining a scale factor that is used to quantize a frequency spectrum converted from the input signal, based on the frequency spectrum characteristic, for each of a plurality of bands; and quantizing the frequency spectrum based on the scale factor.

### CROSS-REFERENCE TO RELATED APPLICATION

This application is based upon and claims the benefit of priority of the prior Japanese Patent Application No. 2012-234870, filed on Oct. 24, 2012, the entire contents of which are incorporated herein by reference.

### FIELD

The embodiments discussed herein are related to an audio coding device, an audio coding method, an audio coding and decoding system, and a computer-readable recording medium configured to store an audio coding program.

### BACKGROUND

In the related art, various studies have been made for an audio coding technology by which an audio signal (sound source of sound, music or the like) is compressed and decompressed. For example, various studies have been made for a method of converting the audio signal into frequency domain and coding the converted audio signal.

For example, as such audio coding technology, there are an advanced audio coding (MC) scheme, a high efficiency-advanced audio coding (HE-AAC) scheme, and the like. The MC scheme and the HE-AAC scheme are one of a MPEG-2/4 audio standard of ISO/IEC, and are widely used for digital broadcasting (terrestrial, BS, or CS broadcasting), and the like in Japan.

In such an audio coding technology, a coding device that executes audio coding converts an audio signal into a frequency spectrum by modified discrete cosine transform (MDCT), and quantizes such a frequency spectrum to code the quantization value.

In the above-described audio coding technology, the frequency spectrum is quantized using an auditory masking characteristic. For example, only sound that is audible for a user is quantized using a masking threshold value that is a threshold value indicating whether the sound is audible or not and used to determine a component of inaudible sound, which is masked by a certain sound.

For example, in an audio coding device in the related art, for an audio signal (sound source to be coded), psychoacoustic analysis (method of analyzing whether sound is audible or not in the auditory sense) is performed, and a masking threshold value is calculated for each frequency band. After that, the audio coding device determines an allowable error limit (allowable error power) at the time of quantization, from the calculated masking threshold value, for each of the frequency bands (certain frequency widths). In addition, the audio coding device quantizes only a sound source (frequency spectrum) that is audible in the auditory sense, using the allowable error power.

As the related art, Japanese Laid-open Patent Publication No. 2006-18023, Japanese Laid-open Patent Publication No. 2001-7704, Japanese Laid-open Patent Publication No. 7-202823, and Japanese Laid-open Patent Publication No. 7-295594 discuss a method of adjusting a masking threshold value, a method of reducing an amount of bits that are used at the time of coding, and a method of specifying a distribution amount of bits, and the like. In addition, for example, Japanese Laid-open Patent Publication No. 2009-198612 also discusses a method of correcting a scale factor that is used for quantization in order not to deteriorate sound quality when an audio signal having tonality (tone signal) is coded.

For example, when the audio signal having a tone signal (for example, sine waves, sweep waves, or the like) is coded, strength (power [dB], that is, power) is concentrated on a certain band, and the band has a relatively large peak (strength of the frequency spectrum becomes relatively strong) as compared with another band. In the coding of the audio signal having the tone signal, if a frequency spectrum of a frequency spectrum band in the vicinity of the tone signal is not quantized desirably, the frequency spectrum in the vicinity of the tone signal may be lost. The audio signal having the tone signal becomes a sound that has the same level in a time direction. Therefore, the user hears sound being vibrated due to variation in band power of the tone signal band for each frame, so that subjective sound deterioration due to the coding stands out remarkably. Therefore, in the related art, the frequency spectrum of the frequency spectrum band in the vicinity of the tone signal band is quantized by correcting a scale factor to the scale factor that exceeds the masking threshold value.

### SUMMARY

In accordance with an aspect of the embodiments, an audio coding device includes a processor; and a memory which stores a plurality of instructions, which when executed by the processor, cause the processor to execute, calculating a frequency spectrum characteristic of an input signal; defining a scale factor that is used to quantize a frequency spectrum converted from the input signal, based on the frequency spectrum characteristic, for each of a plurality of bands; and quantizing the frequency spectrum based on the scale factor.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a functional block diagram of an audio coding device according to an embodiment;

FIG. 2A is a diagram illustrating a relationship between a frequency band and power of a frequency spectrum;

FIG. 2B is a table illustrating an example of a data structure in tone signal band determination;

FIG. 3A is a diagram illustrating a relationship between a definition coefficient of a scale factor and a tone signal-to-noise ratio;

FIG. 3B is a table illustrating an example of a data structure that includes the tone signal-to-noise ratio and the definition coefficient;

FIG. 4A is a diagram illustrating a relationship between a frequency and a quantization bit rate when a noise band is not included in an audio signal;

FIG. 4B is a diagram illustrating a relationship between a frequency and a quantization bit rate when a noise band is included in an audio signal;

FIG. 5A is a spectrum diagram of original sound of the audio signal that includes the tone signal;

FIG. 5B is a spectrum diagram of an audio signal after decoding, to which coding in a comparative example is applied;

FIG. 5C is a spectrum diagram of an audio signal after decoding, to which coding in a first example is applied;

FIG. 6 is an operation flowchart of audio coding processing;

FIG. 7 is a diagram illustrating functional blocks of an audio coding and decoding system according to an embodiment; and

FIG. 8 is a diagram illustrating hardware configuration of an audio coding device according to an embodiment.

### DESCRIPTION OF EMBODIMENTS

Examples of an audio coding device, an audio coding method, and a computer readable recording medium configured to store an audio coding program, and an audio coding and decoding system according to embodiments are described below. The embodiments are not limited to such examples.

### First Example

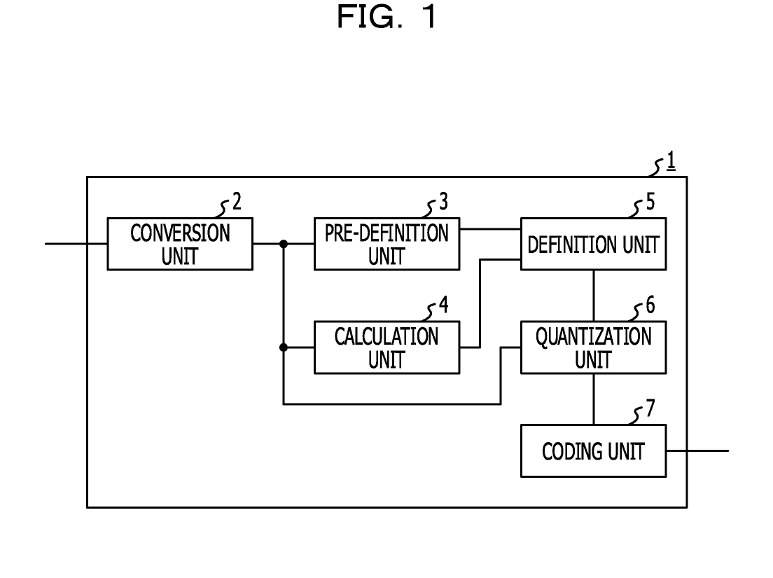

FIG. 1 is a functional block diagram of an audio coding device 1 according to an embodiment. As illustrated in FIG. 1, the audio coding device 1 includes a conversion unit 2, a pre-definition unit 3, a calculation unit 4, a definition unit 5, a quantization unit 6, and a coding unit 7.

Each of the units that are included in the audio coding device 1 is constituted by, for example, a hardware circuit by wired logic, as an individual circuit. Alternatively, the units that are included in the audio coding device 1 may be mounted on the audio coding device 1 as a single integrated circuit in which circuits that respectively correspond to the units are integrated. In addition, each of the units that are included in the audio coding device 1 may be a function module that is realized by a computer program that is executed on a processor that is included in the audio coding device 1.

The conversion unit 2 converts an audio signal that is a signal input from the outside, into a frequency spectrum that includes a plurality of bands. For example, the conversion unit 2 performs time-frequency conversion by the MDCT, on the input audio signal to convert the input audio signal into the frequency spectrum that includes the plurality of bands. Here, the time-frequency conversion is, for example, conversion of an audio signal in which a time is indicated as a parameter (for example, the horizontal axis indicates “time”) into a frequency spectrum that is information in which a frequency is indicated as a parameter (for example, the horizontal axis indicates “frequency”). The conversion unit 2 may convert an audio signal into a frequency spectrum, for example, in accordance with the following equation that is discussed in ISO/IEC13818-7.

$${X}_{k} = 2 \cdot {\sum }_{n = 0}^{N - 1} {Z}_{n} cos ( \frac{2 π}{N} ( n + {n}_{0} ) ( k + \frac{1}{2} ) ) for 0 \leq k < N / 2 \qquad ( equation 1 )$$

Here, “n” indicates a time, “k” indicates a frequency, “Zₙ” indicates “input signal×window”, “N” indicates a window length, and “n₀” indicates (N/2+1)/2.

“Frequency spectrum” corresponds to a coefficient for each frequency (for example, a MDCT coefficient), which is obtained when an audio signal (sound source) is converted into a frequency domain (for example, by the above-described MDCT). A value that is obtained by squaring the frequency spectrum corresponds to “frequency spectrum power”. In addition, in the frequency spectra, a coefficient of a certain frequency when peaks of frequency spectrum power are concentrated on the frequency corresponds to “frequency spectrum having a tone signal”. For example, a frequency spectrum having power that is larger than an average of powers of all frequency spectra corresponds to “frequency spectrum having a tone signal”.

The pre-definition unit 3 receives the frequency spectrum that includes the plurality of bands from the conversion unit 2 and defines a scale factor beforehand as appropriate so that a quantization error in the quantization by the quantization unit 6 that is described later becomes within allowable error power (hereinafter, the scale factor that is defined beforehand as appropriate is referred to as a pre-defined scale factor). The pre-definition unit 3 may define the scale factor beforehand, for example, by the method that is discussed in Japanese Laid-open Patent Publication No. 2009-198612. The function of the pre-definition unit 3 may be integrated with the function of the definition unit 5 that is described later, so that the pre-definition unit 3 may not be desired in the audio coding device 1.

Here, “quantization” is, for example, processing of truncating decimal places of significant digits (for example, making “1.8”, “2.1”, and the like, to integers such as “1”, “2”, and the like). “Quantization value” corresponds to, for example, a value that is obtained by quantizing a frequency spectrum. In addition, “quantization error” corresponds to, for example, an error that occurs for each frequency spectrum by quantizing each of the frequency spectra. For example, a difference between a frequency spectrum before quantization and a spectrum after inverse quantization (hereinafter referred to as “inverse quantization spectrum”) corresponds to the quantization error. For example, “inverse quantization spectrum” corresponds to a frequency spectrum that is obtained from the quantization value.

Here, a relationship between the above-described frequency spectrum, quantization value, and inverse quantization spectrum is described. The quantization unit 6 performs scaling using a certain scale factor in order to reduce a dynamic range of the frequency spectrum. After that, the quantization unit 6 obtains a quantization value by performing the quantization. An audio decoding device may obtain an inverse quantization spectrum by performing rescaling of the quantization value that is received from the audio coding device 1 using a certain scale factor. A relationship between the frequency spectrum, the quantization value, and the scale value may be represented by the following equation.

Frequency spectrum=quantization value×2̂(scale factor) (equation 2)

Here, “2̂(scale factor)” indicates “(scale factor)-th to the power of 2”. In addition, an inverse quantization spectrum is represented by the following equation.

Post-quantization spectrum=quantization value×2̂(scale factor) (equation 3)

In addition, a quantization value is represented by the following equation.

Quantization value=int(frequency spectrum before quantization×2̂(−(scale factor))) (equation 4)

“Scale factor” is assigned, for example, to each band, and such a value that quantization error power becomes less than allowable error power is used for “Scale factor”. The band indicates, for example, each of the areas with a certain width that are obtained by dividing a frequency. The sum of frequency spectrum powers that are included in a band corresponds to “band power” of the frequency spectrum. In addition, “quantization error power” of the frequency spectrum indicates, for example, a value of the square of the quantization error. In addition, “quantization error power in a certain band” indicates, for example, the sum of quantization error powers that are calculated from quantization errors that occur when frequency spectra that are included in the band are quantized. For example, a relationship between a quantization error and quantization error power in a certain band is represented by the following equation.

The quantization error power in the certain band=Σ{(quantization error of each of the frequency spectra that are included in the band)̂2} (equation 5)

Here, “̂2” indicates “square”.

“Allowable error power” corresponds to, for example, the maximum allowable quantization error power at the time of quantization, and is calculated for each of the bands with a certain width that are obtained by dividing a frequency of an audio signal by converting the masking threshold value that is a threshold value calculated for the audio signal and indicates whether or not the sound is audible in the sense of hearing. For example, the method described in ISO/IEC13818-7 may be employed as the method for calculating the allowable error power from the masking threshold value.

That is, the allowable error power corresponds to a limit value of allowable quantization error power. For example, allowable error power in a certain band corresponds to quantization error power that is calculated for the band, and corresponds to the maximum value that is allowable as an error that occurs when a frequency spectrum of the band is quantized. That is, the quantization unit 6 quantizes a frequency spectrum so that a difference between power of a frequency spectrum before quantization and power of an inverse quantization spectrum in the certain band becomes less than the allowable error power.

The allowable error power is converted from the masking threshold value and calculated for each of the bands, is compared with power of the frequency spectrum of each of the bands, and is used to determine a band the frequency spectrum of which is quantized. The power that is compared with the allowable error power when a frequency spectrum to be quantized is determined corresponds to band power that is a comparison target.

A relationship between a scale value, quantization error power, and allowable error power is described below. The quantization unit 6 determines a target band to be quantized when the band power is larger than the allowable error power. In addition, the quantization unit 6 quantizes a frequency spectrum using a scale factor with which quantization error power becomes less than allowable error power. The quantization unit 6 quantizes a frequency spectrum using a scale factor that is defined by the definition unit 5 that is described later. The quantization unit 6 performs the quantization (quant), for example, using the following equation that is discussed in ISO/IEC13818-7.

Quant=INT{abs(Xₖ)×2̂(−1/4×scf)+MAGIC_NUMBER} (equation 6)

Here, “Xₖ” indicates a frequency spectrum, “scf” indicates a scale factor, and “MAGIC_NUMBER” indicates a given fixed value (for example, 0.4054). In addition, a pre-defined scale factor scr that is adjusted by considering a tone signal in the related art is represented by the following equation.

scr=log 2(max-pow-spec/MAX QUANT) (equation 7)

Here, “max-pow-spec” indicates the maximum spectrum in a band, and “MAX QUANT” indicates a quantization value.

The calculation unit 4 receives a frequency spectrum that includes a plurality of bands from the conversion unit 2 and calculates a tone signal-to-noise ratio (SNR) that is one of frequency spectrum characteristics, from the frequency spectrum. The calculation unit 4 may calculates a tone signal band, for example, by the method that is discussed in Japanese Laid-open Patent Publication No. 2009-198612. In addition, the calculation unit 4 may calculate, for example, a band that includes a frequency spectrum having power that is larger than an average of all frequency spectrum powers that are included in the plurality of bands, as the tone signal band, and calculate a band other than the tone signal band as a noise band. The noise band may be referred to as a background noise band. In the first example, the description is made using the tone signal-to-noise ratio as an example of a frequency spectrum characteristic, and for example, other than the tone signal-to-noise ratio, resolution that is defined by a ratio of power in a high frequency and power in a low frequency may be used as the frequency spectrum characteristic.

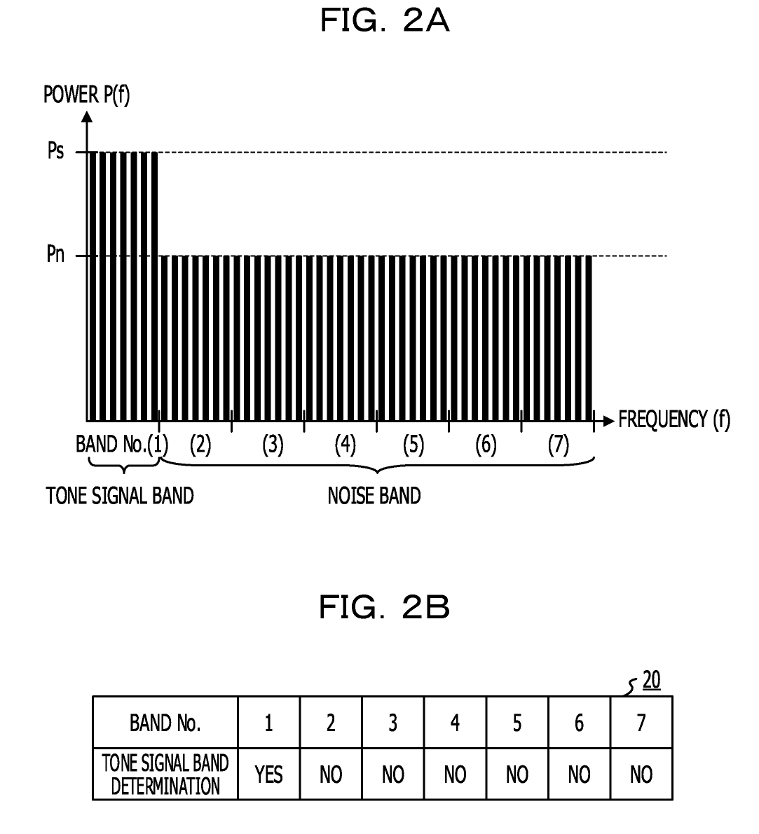

FIG. 2A is a diagram illustrating a relationship between a frequency band and power of a frequency spectrum. FIG. 2B is a table illustrating an example of a data structure in tone signal band determination. As illustrated in FIG. 2A, a frequency spectrum that is received from the conversion unit 2 is divided into a plurality of bands, and a band that includes a tone signal and a band that includes noise are mixed. As illustrated in a table 20 of FIG. 2B, the calculation unit 4 calculates, for example, a band that includes a frequency spectrum having power that is larger than an average of all frequency spectrum powers, as the tone signal band as described above, and stores the calculation result in an item of the tone signal determination for each of the bands. The calculation unit 4 stores “Yes” for a band (f) in which a tone signal band is calculated, and stores “No” for a band (f) other than the above-described band, that is, a noise band.

In FIG. 2A, when power of the tone signal band is indicated by “Ps”, and power of the noise band is indicated by “Pn”, the calculation unit 4 may calculate a tone signal-to-noise ratio (SNR) using the following equation.

SNR=Ps/Pn (equation 8)

The power of the tone signal band (Ps) and the power of the noise band (Pn) in FIGS. 2A and B may be calculated, for example, as represented in the following equation.

$$Pn = {\sum }_{k = 2}^{7} P ( k ) \\ Ps = P ( 1 ) \qquad ( equation 9 )$$

The calculation unit 4 may calculate, for example, various values such as a value that is obtained by standardizing the sum of a tone signal and noise by the noise, may be calculated as the tone signal-to-noise ratio, other than the above-described equation 8.

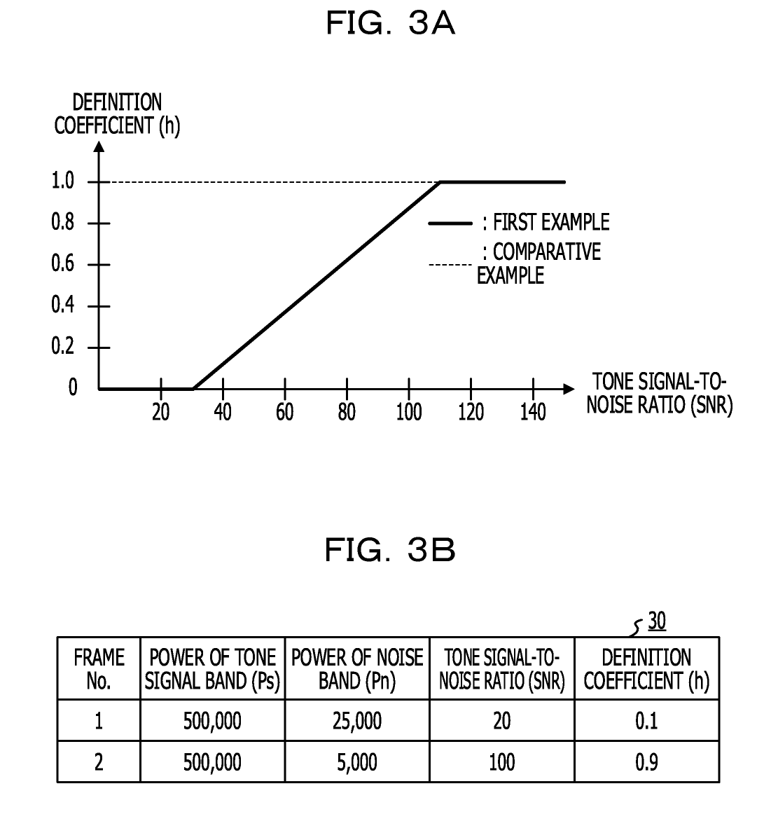

The definition unit 5 in FIG. 1 receives a pre-defined scale factor from the pre-definition unit 3 as appropriate and receives a tone signal-to-noise ratio from the calculation unit 4. The definition unit 5 defines a scale factor by correcting the pre-defined scale factor on the basis of the tone signal-to-noise ratio. FIG. 3A is a diagram illustrating a relationship between a tone signal-to-noise ratio and a definition coefficient of a scale factor. In FIG. 3A, a definition coefficient (h) of a scale factor in the first example becomes zero when the tone signal-to-noise ratio (SNR) is less than 10, and the definition coefficient (h) becomes 1 when the tone signal-to-noise ratio (SNR) is 110 or more. In addition, the definition coefficient (h) may be represented by the following equation when the tone signal-to-noise ratio (SNR) is 10 or more and less than 110.

h=SNR/100−0.1 (equation 10)

In addition, a definition coefficient (h) in a comparative example becomes 1 regardless of the tone signal-to-noise ratio (SNR). The numeric values in FIG. 3A and each of the coefficients in the above-described equation 10 may be defined by a given coefficient. The definition coefficient (h) of the scale factor may be referred to as a first definition amount. In addition, the definition unit 5 may not define the scale factor by correcting the pre-defined scale factor when the calculation unit 4 does not detect a tone signal band, and the pre-defined scale factor may be used as a scale factor after definition. The pre-definition unit 3 may not be included in the audio coding device 1. For example, after the definition unit 5 calculates a tone signal-to-noise ratio, the definition unit 5 may define a scale factor based on the tone signal-to-noise ratio and the above-described equation 7.

FIG. 3B is a table illustrating an example of a data structure that includes a tone signal-to-noise ratio and a definition coefficient. As illustrated in the table 30 of FIG. 3B, the definition coefficient (h) is stored, for example, for each frame of an audio signal. The definition unit 5 defines a scale factor by correcting the pre-defined scale factor that is received from the pre-definition unit 3 using the definition coefficient (h). For example, as represented in the following equation, the definition unit 5 calculates a scale factor (scf″) after definition by correcting a pre-defined scale factor using an identical definition coefficient, for scale factors of all of the plurality of bands.

scf″=(scr″−scf)×h+scf

By multiplying each of the scale factors of all of the plurality of bands by an identical definition coefficient, the following technological effect is obtained. For example, in coding by advanced audio coding (MC), information on a difference between scale factors of adjacent frequency bands is coded. Here, in a scale factor codebook, a short code is assigned as the difference between the scale factors is small. Therefore, the number of coding bits, when the coding unit 7 that is described later performs coding, may be reduced as the difference between the scale factors of the frequency bands is small. Therefore, by keeping the scale factors of the frequency bands which are multiplied by the identical definition coefficient to be the same, the number of coding bits may be reduced.

The quantization unit 6 receives a frequency spectrum that includes a plurality of bands from the conversion unit 2, receives a scale factor from the definition unit 5, and quantizes the frequency spectrum that includes the plurality of bands. For example, the quantization unit 6 reduces a dynamic range of the frequency spectrum, which is included in each of the plurality of bands, to a dynamic range that is uniquely identified by the scale factor after definition. The quantization unit 6 quantizes each frequency spectrum that constitutes each band in the reduced dynamic range.

The quantization unit 6 changes a dynamic range for each of the bands on the basis of the scale factor that is received from the definition unit 5, and may perform quantization for each frequency spectrum that configures each of the bands instead of quantization for each band, at the time of quantization. That is, the quantization unit 6 may obtain a quantization value by performing quantization on each of the frequency spectra. For example, the quantization unit 6 may perform quantization using the pre-defined scale factor when the calculation unit 4 does not detect a tone signal band. When the audio coding device 1 does not include the pre-definition unit 3, the definition unit 5 may define a value that is equivalent to the pre-defined scale factor as a scale factor. The quantization unit 6 quantizes the entire frequency spectrum of the input signal.

The coding unit 7 receives the quantization value and the scale factor after definition from the quantization unit 6, and codes the quantization value and the scale factor after definition, for example, using the Huffman coding. The coding unit 7 outputs the coded data to the outside of the audio coding device.

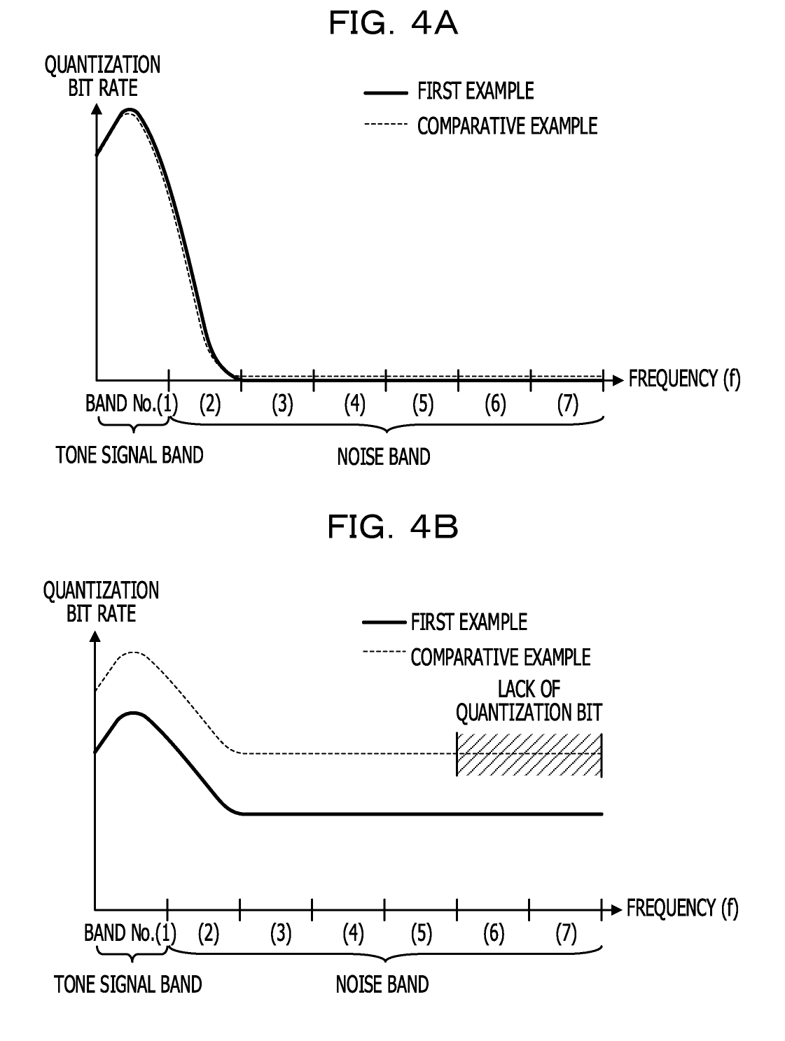

FIG. 4A is a diagram illustrating a relationship between a frequency and a quantization bit rate when a noise band is not included in an audio signal.

FIG. 4B is a diagram illustrating a relationship between a frequency and a quantization bit rate when a noise band is included in an audio signal. As illustrated in FIG. 4A, when a noise band is not included in an audio signal, “SNR=1” is obtained in accordance with the relationship illustrated in FIG. 3A, so that the scale factor is not changed before and after definition, and the quantization bit rate is also not changed.

On the other hand, as illustrated in FIG. 4B, in the case in which a noise band is included in an audio signal, when the pre-defined scale factor in the comparative example is used, a quantization bit amount in the noise band increases greatly in addition to the bit amount in the tone signal band. The total allocation amount of the quantization bits in all of the bands that are obtained by combining the tone signal band and the noise band are uniquely defined by a bit rate, so that lack of a quantization bit occurs when the number of quantization bits in all of the bands is increased and exceeds the total allocation amount of quantization bits. In addition, when a scale factor is defined on the basis of the tone signal-to-noise ratio from the relationship illustrated in FIG. 3A, the above-described equation 8, equation 10, and the like, a usage amount of quantization bit rate may be suppressed appropriately, so that lack of a quantization bit may be suppressed.

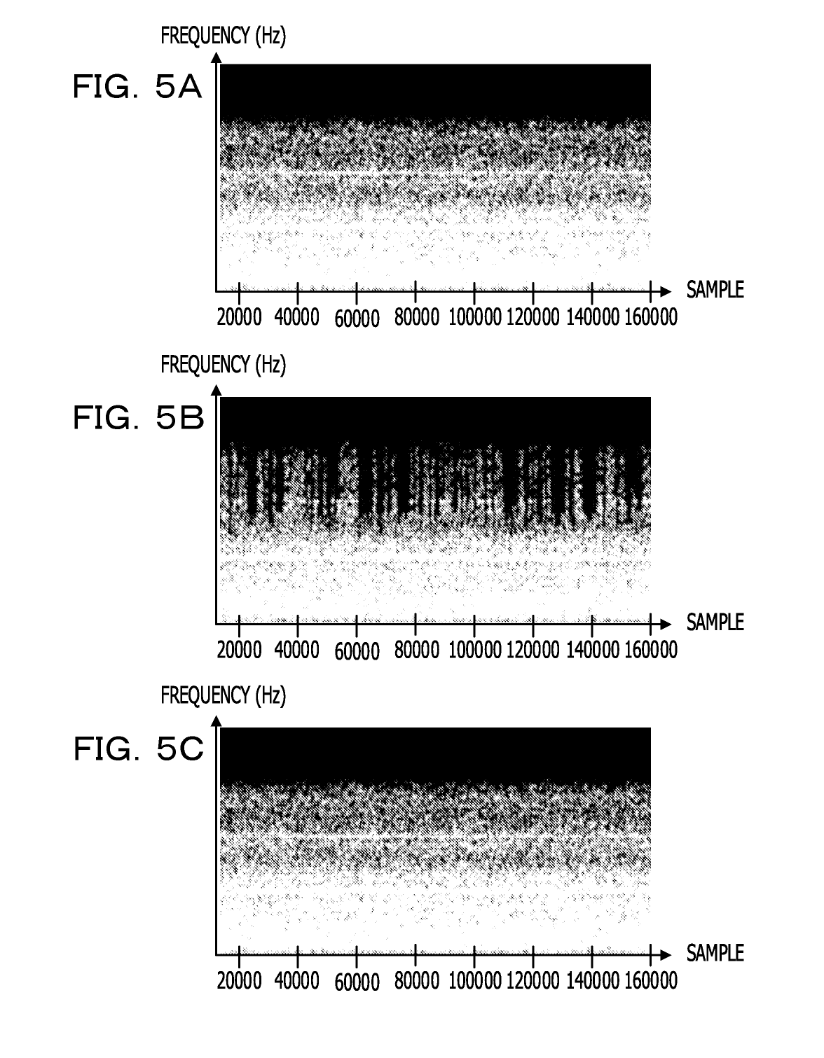

FIG. 5A is a diagram illustrating a spectrum of original sound of an audio signal that includes a tone signal. FIG. 5B is a diagram illustrating a spectrum of an audio signal after decoding, to which the coding according to the comparative example has been applied. In the comparative example of FIG. 5B, the pre-defined scale factor is used. FIG. 5C is a diagram illustrating a spectrum of an audio signal after decoding, to which the coding according to the first example has been applied. In the spectrum diagrams in FIGS. 5A to 5C, the vertical axis indicates a frequency, and the horizontal axis indicates a sampling time. In FIG. 5B, deterioration of a sound quality is found as compared with the spectrum in FIG. 5A. In particular, in a high frequency band of FIG. 5B, lack of a quantization bit irregularly occurs for each unit of a time, and it is found that significant sound quality deterioration occurs. In FIG. 5C, it is found that a sound quality that is substantially the same as that of the spectrum in FIG. 5A is kept. Therefore, in the audio coding device in the first example, even when the noise is superimposed on the tone signal, the sound quality deterioration due to the lack of a quantization bit may be suppressed.

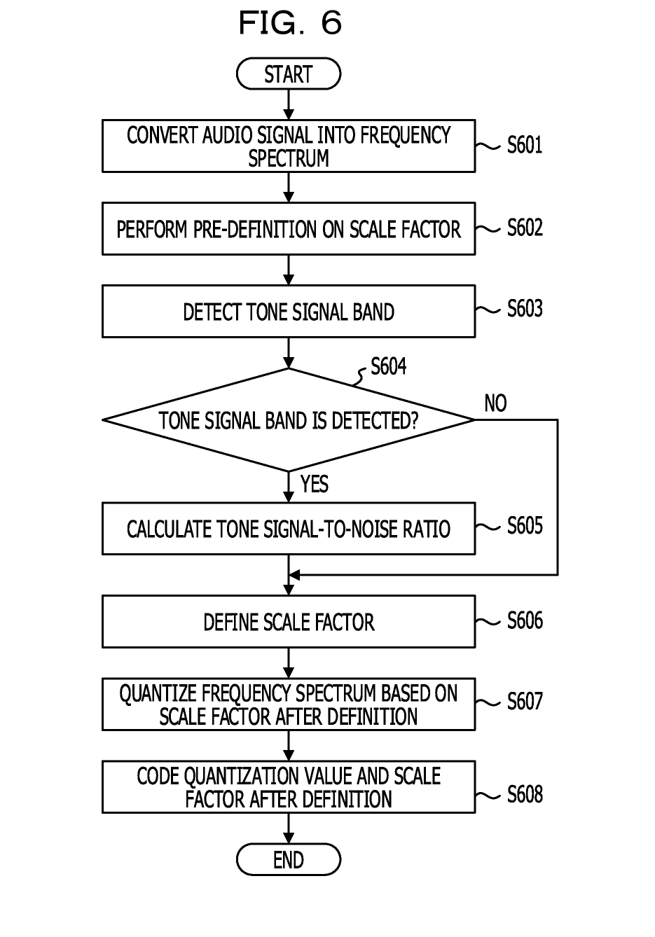

FIG. 6 is an operation flowchart of the audio coding processing. The flowchart illustrated in FIG. 6 indicates processing for an audio signal of one frame. The audio coding device 1 repeatedly executes a procedure of the audio coding processing illustrated in FIG. 6 for each frame in all frequency bands while continuing to receive an audio signal.

The conversion unit 2 converts an audio signal that is a signal input from the outside, into a frequency spectrum that includes a plurality of bands (Step S601). For example, the conversion unit 2 performs the time-frequency conversion on the input audio signal by the MDCT and converts the input audio signal into a frequency spectrum that includes a plurality of bands. The conversion unit 2 outputs the frequency spectrum that includes the plurality of bands, to the pre-definition unit 3, the calculation unit 4, and the quantization unit 6.

The pre-definition unit 3 receives the frequency spectrum that includes the plurality of bands from the conversion unit 2, and defines a scale factor so that a quantization error in quantization by the quantization unit 6 that is described later becomes within allowable error power (Step S602). The pre-definition unit 3 outputs the defined scale factor to the definition unit 5. As described above, the function of the pre-definition unit 3 may be integrated with the function of the definition unit 5, and accordingly the processing of Step S602 may be omitted when the function of the pre-definition unit 3 is included in the definition unit 5.

The calculation unit 4 receives the frequency spectrum that includes the plurality of bands from the conversion unit 2 and detects a tone signal band from the frequency spectrum (Step S603). The calculation unit 4 may detect, for example, a band that includes a frequency spectrum having power that is larger than an average of all frequency spectrum powers, as a tone signal band.

When the calculation unit 4 detects a tone signal band (Yes in Step S604), the calculation unit 4 calculates a tone signal-to-noise ratio (Step S605). The calculation unit 4 calculates, for example, a band that includes a frequency spectrum having power that is larger than an average of all frequency spectrum powers, which are included in the plurality of bands, as the tone signal band, calculates a band other than the above-described band as a noise band, and may calculate a tone signal-to-noise ratio using the above-described equation 8. The calculation unit 4 outputs the calculated tone signal-to-noise ratio to the definition unit 5. In addition, when the calculation unit 4 does not detect a tone signal band (No in Step S604), the calculation unit 4 notifies the definition unit 5 that the calculation unit 4 has not detected a tone signal band.

The definition unit 5 receives a pre-defined scale factor from the pre-definition unit 3 as appropriate and receives a tone signal-to-noise ratio from the calculation unit 4. The definition unit 5 defines a scale factor on the basis of the tone signal-to-noise ratio, the relationship illustrated in FIG. 3A, the above-described equation 10, and the like (Step S606). The definition unit 5 outputs the defined scale factor to the quantization unit 6. In addition, when the definition unit 5 is notified that a tone signal band is not detected from the calculation unit 4, the scale factor may not be defined from the pre-defined scale factor, and may use the pre-defined scale factor as a scale factor after definition. The definition unit 5 outputs the defined scale factor to the quantization unit 6.

The quantization unit 6 receives a frequency spectrum that includes a plurality of bands from the conversion unit 2, receives a scale factor after definition from the definition unit 5, and quantizes the frequency spectrum that includes a plurality of bands (Step S607). For example, the quantization unit 6 reduces a dynamic range of the frequency spectrum, which is included in each of the plurality of bands, to a dynamic range that is uniquely identified by the scale factor. The quantization unit 6 quantizes each of the frequency spectra each of which constitutes the band in the reduced dynamic range. The quantization unit 6 outputs the quantized quantization value and the scale factor after definition, to the coding unit 7.

The coding unit 7 receives the quantization value and the scale factor after definition from the quantization unit 6, and codes, for example, the quantization value and the scale factor after definition, using the Huffman coding (Step S608). By outputting the coded data by the coding unit 7 to the outside, the audio coding device 1 terminates the coding processing illustrated in FIG. 6.

### Second Example

In the first example, the definition unit 5 defines scale factors of all of the plurality of bands, using an identical definition coefficient, however, by appropriately changing a definition amount of the scale factor for each of the bands, a quantization bit rate is reduced, and sound quality deterioration due to lack of a quantization bit may be further suppressed. For example, in a second example, the definition unit 5 defines only a scale factor of a tone signal band.

For example, when the tone signal band is indicated by “Ks”, and the noise signal band is indicated by “Kn”, a band in which a scale factor is defined corresponds to “Ks+Kn” in the case of the first example and corresponds to “Ks” in the case of the second example. Here, in the first example, a usage quantization bit rate that is reduced due to definition of the scale factor becomes proportional to “1−h” (“h” is a definition coefficient). Therefore, a definition coefficient “h′” in the second example may be represented by the following equation using the definition coefficient “h” in the first example. The definition coefficient “h′” may be referred to as a second definition amount.

$$( 1 - {h}^{′} ) = ( 1 - h ) \times \frac{Ks}{Ks + Kn} \qquad ( equation 12 )$$

In the audio coding device in the second example, also, even when noise is superimposed on a tone signal, sound quality deterioration due to lack of a quantization bit may be suppressed.

### Third Example

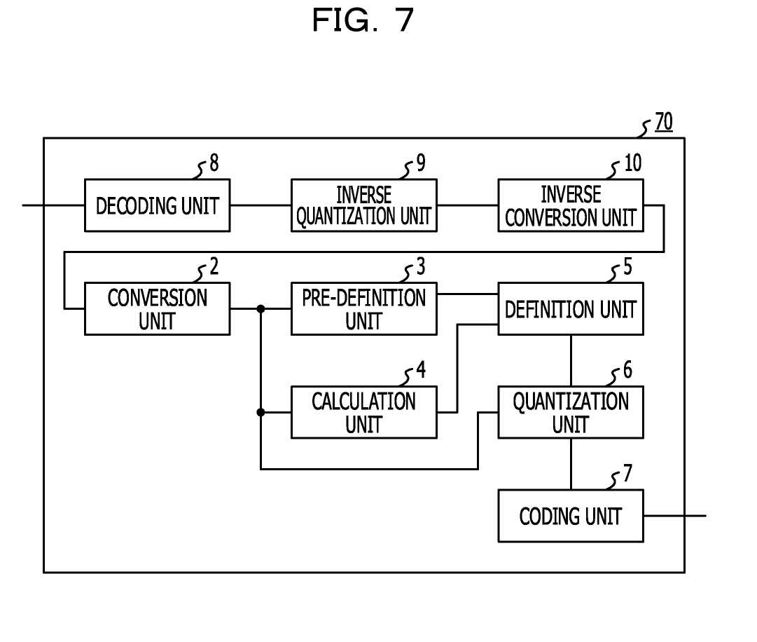

FIG. 7 is a diagram illustrating functional blocks of an audio coding and decoding system 70 according to an embodiment. As illustrated in FIG. 7, the audio coding and decoding system 70 includes the conversion unit 2, the pre-definition unit 3, the calculation unit 4, the definition unit 5, the quantization unit 6, the coding unit 7, a decoding unit 8, an inverse quantization unit 9, and an inverse conversion unit 10.

Each of the units that are included in the audio coding and decoding system 70 is constituted, for example, by a hardware circuit by wired logic as an individual circuit. Alternatively, the units that are included in the audio coding and decoding system 70 may be mounted, as a single integrated circuit in which circuits that respectively correspond to the units are integrated, to the audio coding and decoding system 70. In addition, each of the units included in the audio coding and decoding system 70 may be a function module that is realized by a computer program that is executed on a processor included in the audio coding and decoding device 70.

The decoding unit 8 receives coded data from the outside (for example, from the audio coding device 1), and decodes at least a quantization value and a scale factor from the coded data.

The inverse quantization unit 9 may obtain an inverse quantization spectrum (frequency spectrum) by performing rescaling of the quantization value that is received from the decoding unit 8 using the scale factor that is received from the decoding unit 8.

The inverse conversion unit 10 receives a frequency spectrum from the inverse quantization unit 9 and generates, for example, an audio signal by performing the frequency-time conversion by inverse MDCT.

The functions of the pre-definition unit 3, the calculation unit 4, the definition unit 5, the quantization unit 6, and the coding unit 7 that are illustrated in FIG. 7 are similar to the functions of the units that are illustrated in FIG. 1, and the detailed description is omitted here.

In the audio coding and decoding system in a third example, also, even when noise is superimposed on a tone signal, sound quality deterioration due to lack of a quantization bit may be suppressed.

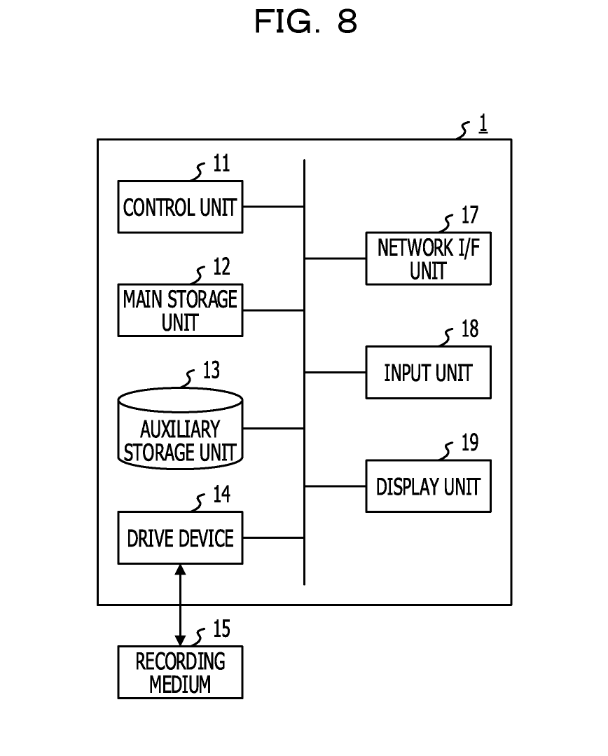

FIG. 8 is a diagram illustrating a hardware configuration of the audio coding device 1 according to an embodiment. As illustrated in FIG. 8, the audio coding device 1 includes a control unit 11, a main storage unit 12, an auxiliary storage unit 13, a drive device 14, a network I/F unit 17, an input unit 18, and a display unit 19. The configuration elements are connected to each other through a bus so as to be allowed to perform transmission and reception of data.

The control unit 11 is a central processing unit (CPU) that performs control of each of the devices and calculation and processing of data in a computer. In addition, the control unit 11 is a calculation device that executes a program stored in the main storage unit 12 and the auxiliary storage unit 13, receives data from the input unit 18 and a storage device, performs calculation and processing on the data, and outputs the data to the display unit 19, the storage device, or the like.

The main storage unit 12 is a read only memory (ROM), a random access memory (RAM), or the like, and is a storage device that stores or temporarily saves an operating system (OS) that is basic software and a program such as application software to be executed by the control unit 11, and data.

The auxiliary storage unit 13 is a hard disk drive (HDD) or the like, and a storage device that stores data related to the application software, and the like.

The drive device 14 reads a program from a recording medium 15 such as a flexible disk, and installs the program into the auxiliary storage unit 13.

In addition, a certain program is stored in the recording medium 15, and the program stored in the recording medium 15 is installed into the audio coding device 1 through the drive device 14. The installed certain program is allowed to be executed by the audio coding device 1.

The network I/F unit 17 is an interface between the audio coding device 1 and a peripheral device having a communication function, which are connected to each other through a network such as a local area network (LAN) or a wide area network (WAN) that is constituted by a transmission path such as a wired and/or wireless line.

The input unit 18 includes a keyboard that includes a cursor key, a numeric number input key, various function keys, and the like, and a mouse and a slice pad that are used to select a key on a display screen of the display unit 19. In addition, the input unit 18 is a user interface that is used when the user gives an operation instruction to the control unit 11 and inputs data.

The display unit 19 is constituted by a cathode ray tube (CRT), a liquid crystal display (LCD), or the like, and performs display based on display data that is input from the control unit 11.

The above-described audio coding method may be realized as a program that the computer is caused to execute. The above-described audio coding method may be realized by installing such a program from a server, or the like, and causing a computer to execute the program.

In addition, the above-described image processing may be realized by recording such a program in the recording medium 15 and causing the computer or a mobile terminal to read the program from the recording medium 15. The recording medium 15 may employ various types of recording mediums, that is, a recording medium that optically, electrically, or magnetically records information such as a compact disc-read-only memory (CD-ROM), a flexible disk, or an opto-magnetic disk, a semiconductor memory that electrically records information such as a ROM or a flash memory, and the like.

The hardware configuration of the above-described audio coding device 1 may employ a configuration that is equivalent to the hardware configuration of the audio coding and decoding system 70 illustrated in FIG. 8.

The computer program that causes the computer to realize the function of each of the units included in the above-described audio coding device according to the embodiments may be provided so as to be stored in a recording medium such as a semiconductor memory, a magnetic recording medium, or an optical recording medium. In addition, an audio signal that is a coding target is not limited to the audio signal of 2ch. For example, the audio signal that is a coding target may be an audio signal that includes a plurality of channels such as 3ch, 3.1ch, 5.1ch, and 7.1ch.

In addition, in the above-described examples, the illustrated configuration elements of each of the devices may not be physically configured as illustrated in the drawings. That is, a specific configuration of distribution and integration of the devices is not limited to the illustrated configuration, and all or some of the devices may be configured so as to be functionally or physically distributed or integrated in a given unit in accordance with various loads, usages, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An audio coding device comprising:
a processor; and
a memory which stores a plurality of instructions, which when executed by the processor, cause the processor to execute,
calculating a frequency spectrum characteristic of an input signal;
defining a scale factor that is used to quantize a frequency spectrum converted from the input signal, based on the frequency spectrum characteristic, for each of a plurality of bands; and
quantizing the frequency spectrum based on the scale factor.

2. The audio coding device according to claim 1,
wherein, in the calculating, a tone signal-to-noise ratio, based on a tone signal of the frequency spectrum that includes the plurality of bands at least one of which includes the tone signal, is calculated as the frequency spectrum characteristic.

3. The audio coding device according to claim 2,
wherein, in the calculating, a tone signal band that is included in the frequency spectrum is detected, a band of the frequency spectrum other than the tone signal band is determined as a noise band, and a ratio of power in the tone signal band to power in the noise band is calculated as the tone signal-to-noise ratio.

4. The audio coding device according to claim 2,
wherein, in the defining, the scale factor for each of the plurality of bands of the tone signal band and the noise band of the frequency spectrum is defined using a first definition amount based on a size of the tone signal-to-noise ratio.

5. The audio coding device according to claim 2,
wherein, in the defining, only the scale factor of the tone signal band is defined using a second definition amount based on the tone signal-to-noise ratio, the tone signal band, and the noise band.

6. The audio coding device according to claim 5,
wherein, in the defining, the scale factor is not defined using one of the first definition amount and the second definition amount when the tone signal band is not detected in the calculating.

7. The audio coding device according to claim 1,
wherein the quantizing quantizes the entire frequency spectrum of the input signal.

8. An audio coding method comprising:
calculating a frequency spectrum characteristic of an input signal;
defining, by a processor, a scale factor that is used to quantize a frequency spectrum converted from the input signal, based on the frequency spectrum characteristic, for each of a plurality of bands; and
quantizing the frequency spectrum based on the scale factor.

9. The audio coding method according to claim 8,
wherein, in the calculating, a tone signal-to-noise ratio, based on a tone signal of the frequency spectrum that includes the plurality of bands at least one of which includes the tone signal, is calculated as the frequency spectrum characteristic.

10. The audio coding method according to claim 9,
wherein, in the calculating, a tone signal band that is included in the frequency spectrum is detected, a band of the frequency spectrum other than the tone signal band is determined as a noise band, and a ratio of power in the tone signal band to power in the noise band is calculated as the tone signal-to-noise ratio.

11. The audio coding method according to claim 9,
wherein, in the defining, the scale factor for each of the plurality of bands of the tone signal band and the noise band of the frequency spectrum is defined using a first definition amount based on a size of the tone signal-to-noise ratio.

12. The audio coding method according to claim 9,
wherein, in the defining, only the scale factor of the tone signal band is defined using a second definition amount based on the tone signal-to-noise ratio, the tone signal band, and the noise band.

13. The audio coding method according to claim 12,
wherein, in the defining, the scale factor is not defined using one of the first definition amount and the second definition amount when the tone signal band is not detected in the calculating.

14. A computer-readable storage medium storing an audio coding computer program that causes a computer to execute processing, comprising:
calculating a frequency spectrum characteristic of an input signal;
defining a scale factor that is used to quantize a frequency spectrum that is converted from the input signal, based on the frequency spectrum characteristic, for each of a plurality of bands; and
quantizing the frequency spectrum based on the scale factor.

15. The computer-readable storage medium according to claim 14,
wherein, in the calculating, a tone signal-to-noise ratio, based on a tone signal of the frequency spectrum that includes the plurality of bands at least one of which includes the tone signal, is calculated as the frequency spectrum characteristic.

16. The computer-readable storage medium according to claim 15,
wherein, in the calculating, a tone signal band that is included in the frequency spectrum is detected, a band of the frequency spectrum other than the tone signal band is determined as a noise band, and a ratio of power in the tone signal band to power in the noise band is calculated as the tone signal-to-noise ratio.

17. The computer-readable storage medium according to claim 15,
wherein, in the defining, the scale factor for each of the plurality of bands of the tone signal band and the noise band of the frequency spectrum is defined using a first definition amount based on a size of the tone signal-to-noise ratio.

18. The computer-readable storage medium according to claim 14,
wherein, in the defining, only the scale factor of the tone signal band is defined using a second definition amount based on the tone signal-to-noise ratio, the tone signal band, and the noise band.

19. The computer-readable storage medium according to claim 18,
wherein, in the defining, the scale factor is not defined using one of the first definition amount and the second definition amount when the tone signal band is not detected in the calculating.

20. An audio coding and decoding system comprising:
a processor; and
a memory which stores a plurality of instructions, which when executed by the processor, cause the processor to execute,
calculating a frequency spectrum characteristic of an input signal;
defining a scale factor that is used to quantize a frequency spectrum that is converted from the input signal, based on the frequency spectrum characteristic, for each of a plurality of bands;
quantizing the frequency spectrum based on the scale factor; and
performing inverse quantization on the quantized frequency spectrum, based on the scale factor.
